(19) United States
(12) Patent Application Publication
(10) Pub. No.: US 2009/0064006 A1
(43) Pub. Date: Mar. 5, 2009

(54) Techniques for Performing Tasks Associated with Custom Folder Controls

(76) Inventors: Indran Naick, Cedar Park, TX (US); Jeffrey K. Wilson, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/847,460

(22) Filed: Aug. 30, 2007

(51) Int. Cl. G06F 3/048

(52) U.S. Cl. 715/764

(57) ABSTRACT

A technique for associating user defined tasks with electronic files includes associating a custom control with an electronic folder. In this case, the custom control corresponds to a user defined task and the electronic folder includes multiple electronic files grouped according to a defined relationship. The user defined task is then executed on at least one of the multiple electronic files when the custom control, which does not correspond to a system control, is selected.

### BACKGROUND

1. Field

This disclosure relates generally to custom folder controls and, more specifically, to techniques for performing tasks associated with custom folder controls.

2. Related Art

In various operating systems (OSs), different types of system controls are widely utilized. For example, at least one OS allows a user to define a user interface (UI) by adding one or more system controls to a surface of an electronic form. In this context, the system control is a component on the form that is used to display information or accept user input. For example, an electronic form may be opened and system controls may be dragged from a toolbox to a desired location on the form in the event a default size for the system control is acceptable. Alternatively, when a default size for a system control is not acceptable, a system control may be appropriately sized after being dragged from a toolbox to a desired location on the form.

At least one OS includes system folders that are designed for a specific purpose and that include related system controls that are intended to function on files with specified file extensions. In this case, a system control causes a desired task (action) to be performed (e.g., on files within an associated system folder). For example, in at least one version of the Windows OS, a “My Documents” system folder is provided that includes a “My Music” system subfolder, a “My Pictures” system subfolder, and a “My Videos” system subfolder. The “My Music” system subfolder is provided to store music files of a user, the “My Pictures” system subfolder is provided to store pictures of the user, and the “My Video” system subfolder is provided to store videos of the user. In this case, each of the system subfolders has one or more associated system controls that allow a user to perform an associated task by selecting one of the system controls.

For example, the “My Music” system subfolder includes a ‘play all’ system control that is designed to play all files in the system subfolder with an associated player, a ‘shop for music online’ system control that is designed to access an online music store, and a ‘copy all items to audio CD’ system control that is designed to copy the files in the system subfolder to a CD. As another example, the “My Pictures” system subfolder includes a ‘view as a slide show’ system control that is designed to display selected files in the system subfolder, an ‘order prints online’ system control that is designed to order prints of selected files from an associated online store, a ‘print pictures’ system control that is designed to print selected files, and a ‘copy all items to audio CD’ system control that is designed to copy files in the system subfolder to a CD. As another example, the “My Videos” system subfolder includes a ‘copy all items to audio CD’ system control that is designed to copy files in the system subfolder to a CD. Following this approach, files of a specific type (file extension) or specific types (file extensions) are stored in associated system subfolders and a task associated with a given one of the system subfolders is intended to be performed on files of the specific type (file extension) or specific types (file extensions).

### SUMMARY

According to one embodiment of the present disclosure, a technique for associating user defined tasks with electronic files includes associating a custom control with an electronic folder. In this case, the custom control corresponds to a user defined task and the electronic folder includes multiple electronic files grouped according to a defined relationship. The user defined task is then executed on at least one of the multiple electronic files when the custom control, which does not correspond to a system control, is selected.

According to one aspect of the present disclosure, a computer system includes a processor and a memory subsystem coupled to the processor. The memory subsystem is configured to store code that when executed by the processor causes the processor to associate a custom control with an electronic folder. The custom control corresponds to a user defined task and the electronic folder includes multiple electronic files grouped according to a defined relationship. The code, when executed by the processor, also causes the processor to execute the user defined task on at least one of the multiple electronic files when the custom control, which does not correspond to a system control, is selected.

According to another aspect of the present disclosure, a technique of associating user defined tasks with electronic files includes associating a custom control with an electronic folder. In this case, the custom control corresponds to a user defined task and the electronic folder includes multiple electronic files grouped according to a defined relationship. The technique also includes internally inspecting at least one of the multiple electronic files to retrieve content and executing the user defined task on at least one of the multiple electronic files when the custom control, which does not correspond to a system control, is selected. In this case, the retrieved content is utilized in the execution of the user defined task.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of an example computer system whose operating system (OS) may be configured with custom folder controls, according to an embodiment of the present disclosure.

FIG. 2 is a flow chart of a process for adding custom controls to folders, according to one embodiment of the present disclosure.

### DETAILED DESCRIPTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer-usable or computer-readable medium may be utilized. The computer-usable or computer-readable medium may be, for example, but is not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, or communicate the program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages. The program code may execute entirely on a single computer, on multiple computers that may be remote from each other, or as a stand-alone software package. When multiple computers are employed, one computer may be connected to another computer through a local area network (LAN) or a wide area network (WAN), or the connection may be, for example, through the Internet using an Internet service provider (ISP).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

According to various aspects of the present disclosure, techniques are disclosed herein that allow a user to add one or more custom controls to a folder of an operating system (OS). In at least one embodiment, a custom folder control, when selected by a user, is configured to retrieve desired information from one or more files within an associated folder. For example, a custom control may be added to a folder that searches one or more selected files within the folder to retrieve various information (e.g., one or more telephone numbers for a contact, one or more email addresses for a contact, or both telephone numbers and email addresses for a contact) from the one or more selected files in the folder. The telephone numbers may then be displayed or provided to an application that, for example, initiates a voice over Internet protocol (VoIP) telephone call to a retrieved telephone number. Similarly, the retrieved email addresses may then be displayed or provided to an email application that, for example, initiates an email exchange with the retrieved email address. The telephone numbers, email addresses, contact names, etc., may be arranged within a file in the folder in any number of different known ways.

In at least one embodiment, the information may be extracted and displayed in response to a single selection (e.g., a mouse click). According to another aspect of the present disclosure, information in an address book may be automatically mapped to one or more files in a given folder or sub-folder. For example, information in the address may be automatically mapped to a file when some of the information in an address book entry matches some of the information in the file. In this manner, one or more address book entries may be launched based on information within a file in a folder. As used herein, the term “coupled” includes both a direct electrical connection between blocks or components and an indirect electrical connection between blocks or components achieved using intervening blocks or components.

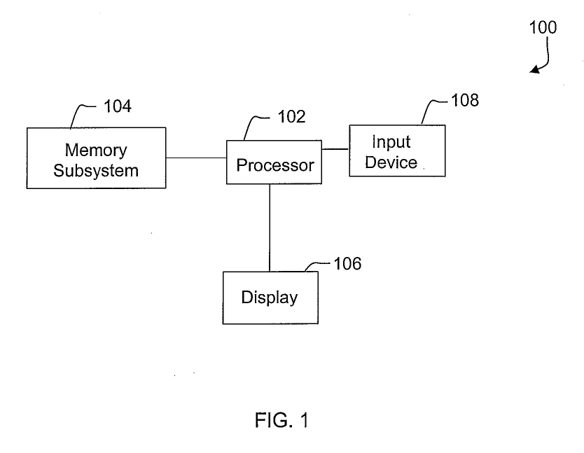

With reference to FIG. 1, an example computer system 100 is illustrated that may implement an operating system (OS) that employs custom folder controls according to one or more aspects of the present disclosure. Custom controls may be created in a Windows-based environment in a number of different ways. Developing custom controls is analogous to developing “macros” for applications and developing plug-ins for browsers. Plug-ins frequently use some aspect of a file displayed or other resources to perform some action. References on developing directory browser components or other related software user interface components are documented in various object oriented programming application programmer interfaces (APIs). As is shown, the system 100 includes a processor 102 that is coupled to a memory subsystem 104, a display 106, and an input device 108. The processor 102 may include one or more central processing units (CPUs). The memory subsystem 104 includes an application appropriate amount of volatile memory (dynamic random access memory (DRAM), synchronous DRAM (SDRAM), etc.) and non-volatile memory (read-only memory (ROM), erasable programmable ROM (EPROM), electrically erasable programmable ROM (EEPROM), flash, etc.). The input device 108 may include a keyboard, a mouse, etc. The display 106 may be, for example, a cathode ray tube (CRT) or a liquid crystal display (LCD).

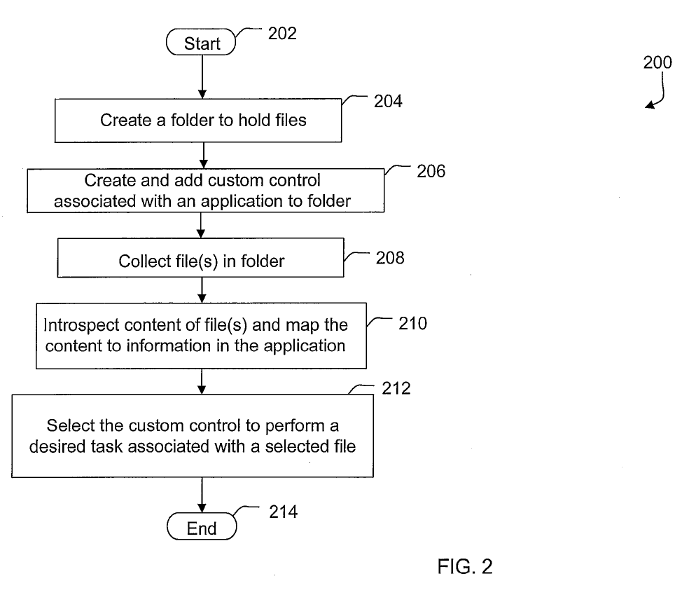

Moving to FIG. 2, an example process 200 for creating custom folder controls is illustrated. In block 202, the process 200 is initiated at which point control transfers to block 204. In block 204, a user creates a folder to hold files using, for example, a system control. Next, in block 206, a custom control that is associated with an application (e.g., a VoIP application or an email application) is created and added to the folder that was created. Alternatively, block 204 may be omitted when the custom control is added to an existing folder. Then, in block 208, one or more files are collected in the folder or sub-folders of the folder. The files may, for example, correspond to receipts associated with a variety of transactions. For example, the files may correspond to invoices emailed to a user that are stored locally, hard copy invoices that have been scanned as bit map (BMP) files, joint picture expert group (JPEG) files, portable data files (PDF), tagged image file format (TIFF) files, a locally stored confirmation web page in hypertext markup language (HTML), or digitally recorded verbal order confirmations. In this case, it should be appreciated that the files may have a variety of different extensions (e.g., bmp, jpg, au, mp3, doc, html) even though the files may belong to the same category, e.g., receipts.

Next, in block 210, the content of the files in the folder are inspected (using known techniques) and the content is mapped to a desired application. For example, the Windows OS includes a “find” feature that is configured to inspect content of a file to determine if the file includes a user entered search term. The one or more files may include contact names, telephone numbers, and email addresses that may be mapped to an address book application. Then, in block 212, a custom control is selected by a user to perform a desired task associated with a selected file or files. For example, a contact name may be displayed along with an associated email address or an associated telephone number. The contact may then be automatically contacted by telephone using a VoIP application or by email using an email application. As another example, the task may correspond to multiple tasks, such as creating a PDF file of a selected file and emailing the PDF file to a desired recipient. Following block 212, control transfers to block 214 where the process 200 returns to a calling process. Accordingly, techniques have been disclosed herein that readily facilitate creation and utilization of custom folder controls.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of associating user defined tasks with electronic files, comprising:
associating a custom control with an electronic folder, wherein the custom control corresponds to a user defined task and the electronic folder includes multiple electronic files grouped according to a defined relationship; and
executing the user defined task on at least one of the multiple electronic files when the custom control is selected, wherein the custom control does not correspond to a system control.

2. The method of claim 1, wherein the method further comprises:
internally inspecting at least one of the multiple electronic files to retrieve content; and
utilizing the retrieved content in the execution of the user defined task.

3. The method of claim 2, wherein the multiple electronic files are related by subject matter.

4. The method of claim 2, wherein the executing the user defined task further comprises:
automatically emailing at least one of the multiple electronic files to a desired recipient that is identified by the retrieved content.

5. The method of claim 2, wherein the executing the user defined task further comprises:
creating at least one portable data file from at least one of the multiple electronic files; and
automatically emailing the at least one portable data file to at least one desired recipient that is identified by the retrieved content.

6. The method of claim 2, wherein the executing the user defined task further comprises:
encrypting at least one of the multiple electronic files; and
automatically emailing at least one of the multiple electronic files in encrypted form to a desired recipient that is identified by the retrieved content.

7. The method of claim 1, wherein the associating a custom control further comprises:
associating the custom control with the electronic folder, wherein the electronic folder includes one or more electronic subfolders each of which includes one or more additional electronic files.

8. A computer system, comprising:
a processor; and
a memory subsystem coupled to the processor, wherein the memory subsystem is configured to store code that when executed by the processor causes the processor to:
associate a custom control with an electronic folder, wherein the custom control corresponds to a user defined task and the electronic folder includes multiple electronic files grouped according to a defined relationship; and
execute the user defined task on at least one of the multiple electronic files when the custom control is selected, wherein the custom control does not correspond to a system control.

9. The computer system of claim 8, wherein the code is further configured to cause the processor to:
internally inspect at least one of the multiple electronic files to retrieve content; and
utilize the retrieved content in the execution of the user defined task.

10. The computer system of claim 9, wherein the multiple electronic files are related by subject matter.

11. The computer system of claim 9, wherein the code is further configured to cause the processor to:
automatically email at least one of the multiple electronic files to a desired recipient that is identified by the retrieved content.

12. The computer system of claim 9, wherein the code is further configured to cause the processor to:
create at least one portable data file for at least one of the multiple electronic files; and
automatically email the at least one portable data file to at least one desired recipient that is identified by the retrieved content.

13. The computer system of claim 9, wherein the code is further configured to cause the processor to:
encrypt at least one of the multiple electronic files; and
automatically email at least one of the multiple electronic files in encrypted form to a desired recipient that is identified by the retrieved content.

14. The computer system of claim 8, wherein the code is further configured to cause the processor to:
associate the custom control with the electronic folder, wherein the electronic folder includes one or more electronic subfolders each of which includes one or more additional electronic files.

15. A method of associating user defined tasks with electronic files, comprising:
associating a custom control with an electronic folder, wherein the custom control corresponds to a user defined task and the electronic folder includes multiple electronic files grouped according to a defined relationship;
internally inspecting at least one of the multiple electronic files to retrieve content; and
executing the user defined task on at least one of the multiple electronic files when the custom control is selected, wherein the retrieved content is utilized in the execution of the user defined task and the custom control does not correspond to a system control.

16. The method of claim 15, wherein the executing the user defined task further comprises:
automatically emailing at least one of the multiple electronic files to a desired recipient that is identified by the retrieved content.

17. The method of claim 15, wherein the executing the user defined task further comprises:
creating a portable data file from at least one of the multiple electronic files; and
automatically emailing the portable data file to at least one desired recipient that is identified by the retrieved content.

18. The method of claim 15, wherein the executing the user defined task further comprises:
encrypting at least one of the multiple electronic files; and
automatically emailing at least one of the multiple electronic files in encrypted form to a desired recipient that is identified by the retrieved content.

19. The method of claim 15, wherein the associating a custom control further comprises:
associating the custom control with the electronic folder, wherein the electronic folder includes one or more electronic subfolders each of which includes at least one additional electronic file.

20. The method of claim 15, wherein the multiple electronic files are related by subject matter.
